(19) United States
(12) Patent Application Publication
(10) Pub. No.: US 2025/0045035 A1
(43) Pub. Date: Feb. 6, 2025

(54) METHOD FOR PREDICTION OF SYSTEM-WIDE FAILURE DUE TO SOFTWARE UPDATES

(71) Applicant: Sony Interactive Entertainment Inc., Tokyo (JP)

(72) Inventors: Rossen Asenov, San Francisco, CA (US); Chandanit Lausoonthorn, San Jose, CA (US); Shingo Yamade, San Jose, CA (US); Manjari Sharda, San Francisco, CA (US); Michael Stopa, Los Altos Hills, CA (US); Rohan Bangdiwala, Hayward, CA (US); Noah Gould, San Francisco, CA (US); Vaibhav Aggarwal, San Francisco, CA (US)

(21) Appl. No.: 18/228,540

(22) Filed: Jul. 31, 2023

(51) Int. Cl. G06F 8/65; G06N 3/08; G06N 5/022

(52) U.S. Cl. CPC G06F 8/65; G06N 3/08; G06N 5/022

(57) ABSTRACT

A device and method for predicting a system failure from update data comprising two or more unimodal modules configured to determine feature information regarding an update to a code section. A neural network is trained with a machine learning algorithm to predict a system failure probability for the code update data that modifies the code section. The trained neural network is provided with the feature information from the two or more unimodal modules.

### FIELD OF THE DISCLOSURE

Aspects of the present disclosure relate to avoiding computer system failures due to updates, specifically aspects of the present disclosure relate to prediction of system-wide failures due to software updates.

### BACKGROUND OF THE DISCLOSURE

The code base of computer systems has become complex with many interdependent blocks of code. Updating these computer systems with complex code bases is difficult because a change to one code block may affect the operation of other code blocks in the code base.

Developers pushing updates may use a tracing tool to prevent system failures due to the updates. The tracing tool informs the developer of the different systems with which a service under inspection communicates. While the tracing tool is useful in providing a clear view of a service architecture and interconnection it does little to warn developers that an update to a particular section of code will cause the system to fail.

Some systems provide a lot of information for developers to determine the cause of a system crash. Using this information, senior developers may gain an understanding of the system and what sort of changes to code blocks within the system may cause it to crash

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 shows a multi-modal neural network trained with a machine learning algorithm to predict a probability of system failure due to an update on a code section.

FIG. 2 is a block diagram showing elements of the connectivity map according to aspects of the present disclosure.

FIG. 3 is a table depicting an example implementation of a history map for a code section that will be modified by an update according to aspects of the present disclosure.

FIG. 4 is a diagram depicting an example implementation of an activity map according to aspects of the present disclosure.

FIG. 5 is a diagram depicting an example of a complexity map according to aspects of the present disclosure.

FIG. 6 is a diagram depicting an example of a social map according to aspects of the present disclosure.

FIG. 7 is a diagram depicting comment sentiment analysis according to aspects of the present disclosure.

FIG. 8 is a diagram depicting an example of a failure map according to aspects of the present disclosure.

FIG. 9A is a simplified node diagram of a recurrent neural network according to aspects of the present disclosure.

FIG. 9B is a simplified node diagram of an unfolded recurrent neural network according to aspects of the present disclosure.

FIG. 9C is a simplified diagram of a convolutional neural network according to aspects of the present disclosure.

FIG. 9D is a flow diagram of a method for training a neural network that is part of multimodal processing according to aspects of the present disclosure.

FIG. 10 is a block diagram of a system implementing the prediction of a system wide failure according to aspects of the present disclosure.

FIG. 11 is a flow diagram showing the method of operation for prediction of a system wide failure from update data according to aspects of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, examples of embodiments of the invention described below are set forth without any loss of generality to, and without imposing limitations upon, the claimed invention.

It is desirable to develop a way to predict system failures from update data using the information from prior crashes. Machine learning algorithms may allow machines to predict the outcome of events based on information from prior events. Multimodal machine learning may allow different types of training information to be combined to make a prediction. System crash logging may provide a large number of different types of information about the system state before and during a system crash. This information may be decomposed by unimodal modules that operate on a single aspect of the information and generate feature information. The feature information may be provided to a multi-modal neural network. Thus, the crash information may be used as training data for a multi-modal neural network to train the multi-modal neural network with a machine learning algorithm to predict whether a change to a particular code section will cause a system crash. Developers also have additional information about the system including code comments and connectivity maps. Code comments may provide insight from the person who wrote the original code block as to the function or importance of various parts of the code. This information may be useful in determining whether a particular change will cause the system to fail and thus may be a source of training data. A connectivity map or data tracing may provide information about what code sections are called by other parts of the system and what other parts of the system are reliant on a particular code section. This may be useful in determining whether a particular code section can be deleted or changed during an update. Finally, information about the person pushing the code section update may be valuable in determining the success of the update. For example, a brand-new developer may be more likely to write an update that breaks a code section than an experienced tenured developer. With these types of training data, a neural network may be trained to predict the probability of an update causing a system failure.

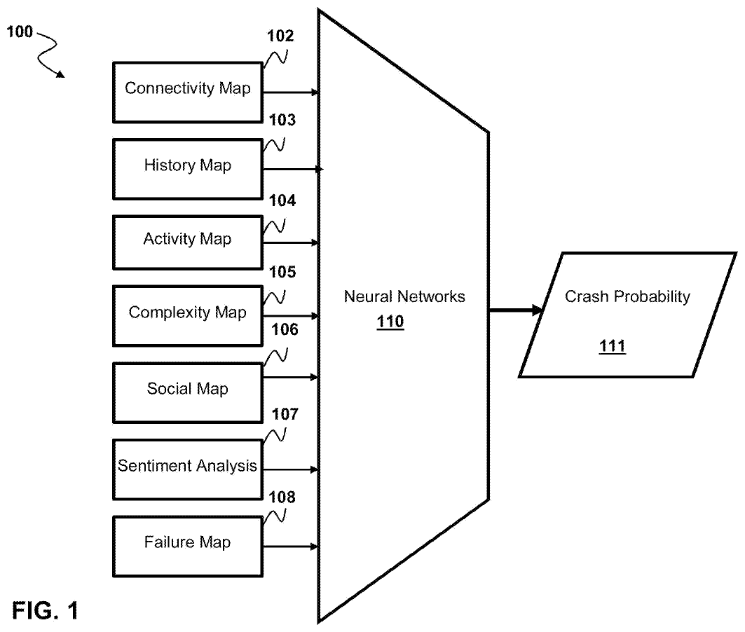

FIG. 1 shows a multi-modal neural network trained with a machine learning algorithm to predict a probability of system failure due to an update on a code section. As shown, the device for prediction of a probability of system failure from an update of a code section 100 may include modules of different modalities that provide feature information to a multi-modal neural network 110. In the implementation shown the multimodal neural network 110 receives feature information from the following modules: a connectivity map 102, a history map 103, an activity map 104, a complexity map 105, a social map 106, sentiment analysis 107, and a failure map 108.

The multi-modal neural network 110 may be trained using a machine learning algorithm to predict the probability of a system failure 111 from the feature information provided by modules 102 to 108.

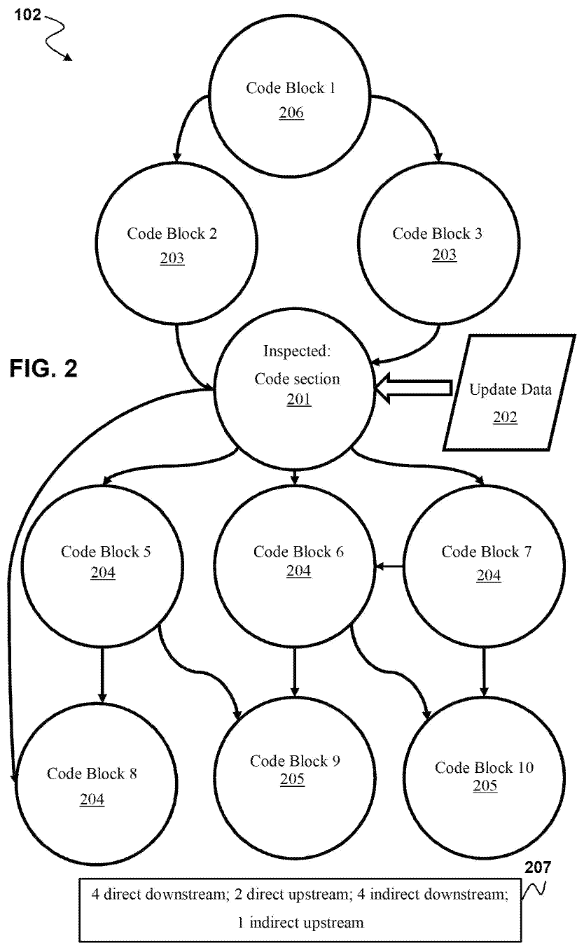

FIG. 2 is a block diagram showing elements of the connectivity map 102 according to aspects of the present disclosure. In the implementation shown the connectivity map may include a depiction of the connections of a code section under review 201. The code section under review 201 may be one or more pieces of code that will be modified by update data 202. The connectivity map 102 may provide both upstream code blocks or nodes 203, 206 and downstream code blocks or nodes 204, 205. The feature information 207 generated by the connectivity map may be for example and without limitation, the number of upstream and downstream code blocks connected to codes section 201 that may be modified by the update 202. In an alternative implementation the feature information 207 may include more granular connection information about the code section that will be updated, for example and without limitation the feature information may include how many upstream code blocks and/or how many downstream code blocks are in connection with the code section under examination 201. In yet other alternative implementations, the feature information may include direct upstream code blocks, indirect upstream code blocks, direct downstream code blocks, indirect downstream code blocks or any combination thereof. In some implementations, a machine language graph may be used as part of the feature information that a model uses as inputs.

Here a connection between the code section under examination and other code blocks may be a call from the code section to another code block or a call from another code block to the code section under examination. An upstream code block may be a code block that makes a call to the code section under examination and a downstream code block may be a code block that is called by the code section under examination. Additionally, an upstream or downstream code block may be indirectly connected or directly connected. A directly connected code block may be a block of code that results in a call to the code section under examination or a code block directly called by the code section under examination. An indirectly connected code block is a code block that calls upon a code block that calls the code section under examination or a code block that is called by a code block that is called by the code section under examination. The indirect connections reported in feature information may be first order or higher order. For example and without limitation, a second order indirect connection may be a first block that calls a second block, which calls a third block that calls the code section under examination.

The connectivity map 102 may be generated by for example and without limitation a control flow graph (e.g., a call graph) generated by the code developers, a code compiler, or similar. The control flow graph may be created by parsing the code and generating an abstract syntax tree that includes nodes for each construct occurring in the code with connections between each node that are determined by the construct. The abstract syntax tree may then be traversed to determine function calls and their corresponding targets within the code. The function calls and their targets may be tracked and recorded graphically in the connectivity map 102. Indirect function calls having a target that is determined dynamically at runtime may then be determined using pointer analysis or similar, to infer the dynamically determined targets.

In alternative implementations, the control flow graph may be in a document format that can be fed into Large Language Model.

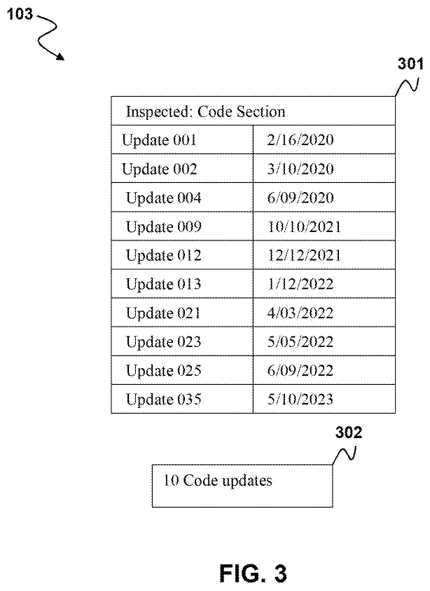

The table in FIG. 3 depicts an example implementation of a history map 103 for a code section that will be modified by an update according to aspects of the present disclosure. As shown in the history map 103 may include a table 301 with entries for each time an update modifies the section under examination. In the implementation shown the entries may include, e.g., an update name and the date of the update to the code section. The code section may encompass multiple code blocks in which case entries for updates made to each code block may be included in the table 301. Feature information 302 may be generated from the table and may include for example and without limitation the number of changes made to the code section under examination. Where the code section encompasses multiple code blocks, the feature information may identify the blocks that were changed and the nature of the changes, e.g., whether the block was deleted or modified. In the case of a modified block, the feature information may specify the nature of the modification, e.g., feature information for a change to a target of a call made by the block might specify the original target and the modified target.

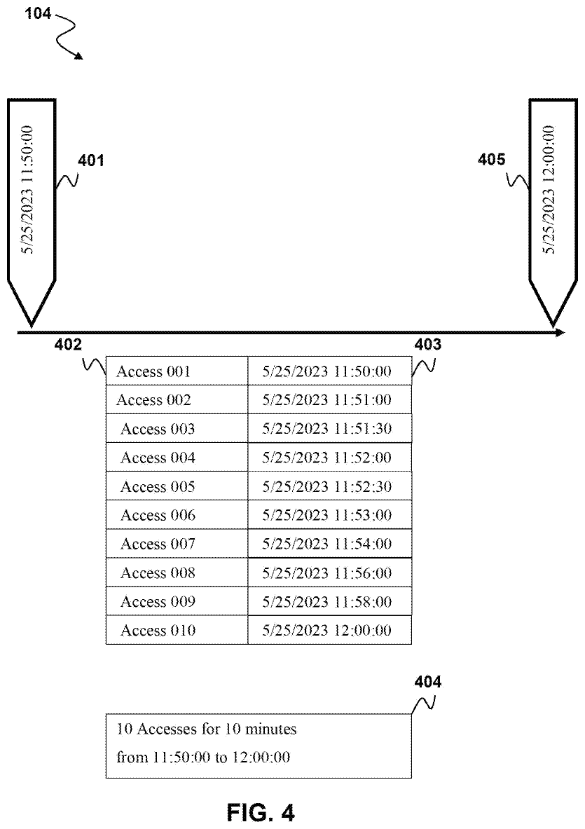

FIG. 4 is a diagram depicting an example implementation of an activity map 104 according to aspects of the present disclosure. As shown the activity map 104 may include a table 402 showing accesses to the code section under examination by time 403. The table may be limited to within a specific time period. As shown the current table has a time period of 10 minutes starting 401 at 11:50:00 on May 25, 2023, and ending 405 at 12:00:00 on May 25, 2023. The feature information 404 generated may include the number of Accesses to the code section under examination. Additionally in some implementations the feature information 404 may also include the time period and/or date over which the accesses occurred. In some alternative implementations the activity map and corresponding feature information may show the number of accesses over the lifetime of an application that includes the code section under examination. Here, accesses herein refer to calls made to the code section under examination and references from other code blocks to the code section under examination when under ordinary operating conditions. In some implementations the activity map may be referred to as code coverage and may express how many constructs in the code out of all the constructs found in the code were executed during a test run of the application. The constructs may be one or more of, for example and without limitation functions, statements, branches, conditions or lines of code.

In some implementations, to generate the activity map, information about systems running the application that includes the code section under examination may periodically send information about the code blocks executed by the system during run time to a diagnostic server. This information may then be analyzed to generate the activity map. The analysis for example and without limitation may be average accesses to the code section during a time period between different instances of the application. Alternatively, the information may be generated from a single example application instance representing normal application operation. There may be different processes for capturing features of the activity map that occur at different time scales. For example, an offline job may determine slow-changing features of the activity map. Another streaming process may create near real-time online features to be used by the model. In some alternative implementations the access information may be generated from crash reports with time periods selected for when the application is operating normally.

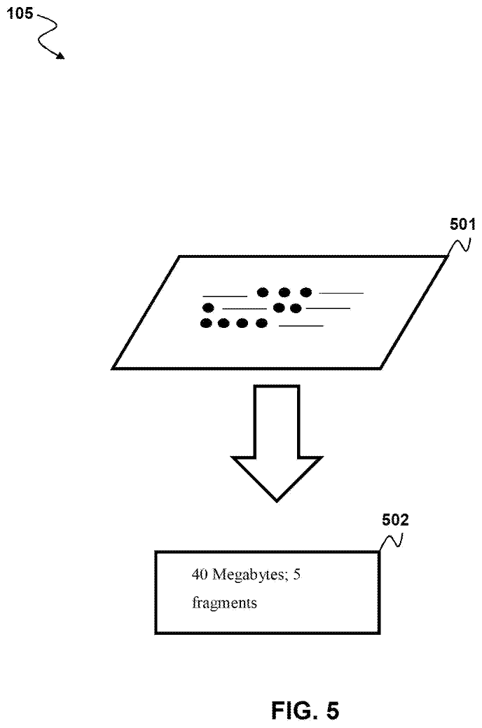

FIG. 5 is a diagram depicting an example of a complexity map 105 according to aspects of the present disclosure. In the implementation shown the complexity of the code section that will be modified by update data is simply measured by how fragmented the code section is. Fragmentation here refers to how non-contiguous is the code section that will be modified by update data. For example without limitation, update data may modify code that is spread throughout the application with many blocks of unmodified code between the areas of code that will be modified, this type of update would be highly fragmented. As shown the fragmentation of the code 501 may be displayed graphically with lines representing the portions of the code section under examination and dots representing code blocks that will not be modified by update data. The feature information 502 may include a size of the code section being modified and number of fragments of code in the code section.

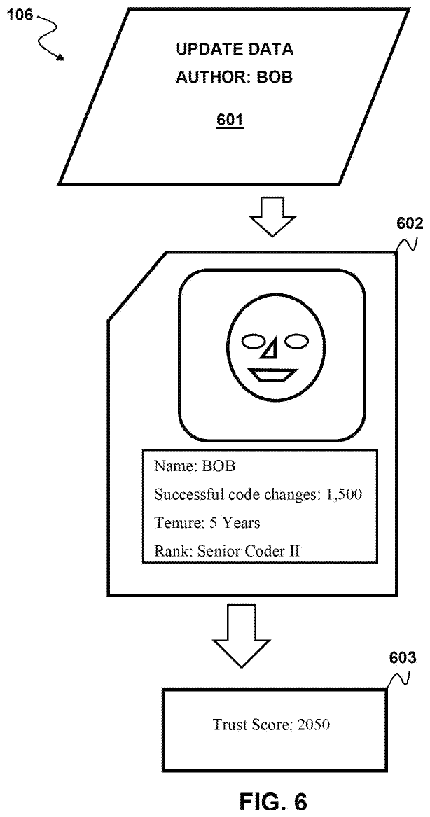

FIG. 6 is a diagram depicting an example of a social map 106 according to aspects of the present disclosure. As shown, update data 601 may include information pointing to the author or authors of the update. Here, the author of update data 601 is Bob. In some implementations the information pointing to the author may include an employee identification number, contact information or other information that may be used to determine the identity of the code author or authors.

The social map may use the information included with the update data to look up an author profile 602. The author profile may be a company employee profile, professional directory entry or social media profile. The social map may scan the author profile 602 for social data. Social data may include for example and without limitation tenure at a company, company rank, years of coding experience, number of prior successful code changes, education level, number of code changes, size of prior code changes, or any other information about the author or authors that may describe competence. In some implementations, the author profile may also include a number of rollbacks a developer has.

The social map may include components configured to facilitate scanning of author profile information. In some implementations the author profile may be formatted in computer readable form in which case the social map may simply access the computer readable information in the author profile. In alternative implementations, the social map may include an optical character recognition (OCR) component configured to convert non-computer readable text into computer readable text. In yet other alternative implementations, the social map may include a social profile database component that allows entry of author information. The social profile database may maintain records of author information and allow referencing to previously entered author information. The social map may also include a natural language processing (NLP) component configured to discover key words or phrases relating to social data in the text. Once the social data is determined the social map may generate social feature information 603.

In the implementation shown the social feature information 603 includes a trust score. A trust score may be for example and without limitation a score generated from the summation of the different weighted factors in the social data. An example trust score equation may be for example and without limitation:

$$Trust = ( 100 * ( Tenure ) ) + ( 1 * ( \# of successful code changes ) ) + ( 10 * ( Rank ) )$$

The trust score may be any score that quickly indicates the coding competence of the author or authors of the update. In some alternative implementations the social feature information 603 may include a single factor from the social data (e.g., tenure or successful code changes, or rank). In yet other alternative implementations, the social feature information may include two or more different factors from the social data. Social data may capture information about the reliability and experience of the person or persons who wrote the update data which may not immediately be apparent from the code itself. Additionally, it may prevent someone who lacks adequate experience from implementing an update, as the social feature information may be an input to the multi-modal neural network which may provide a low score for inexperienced coders.

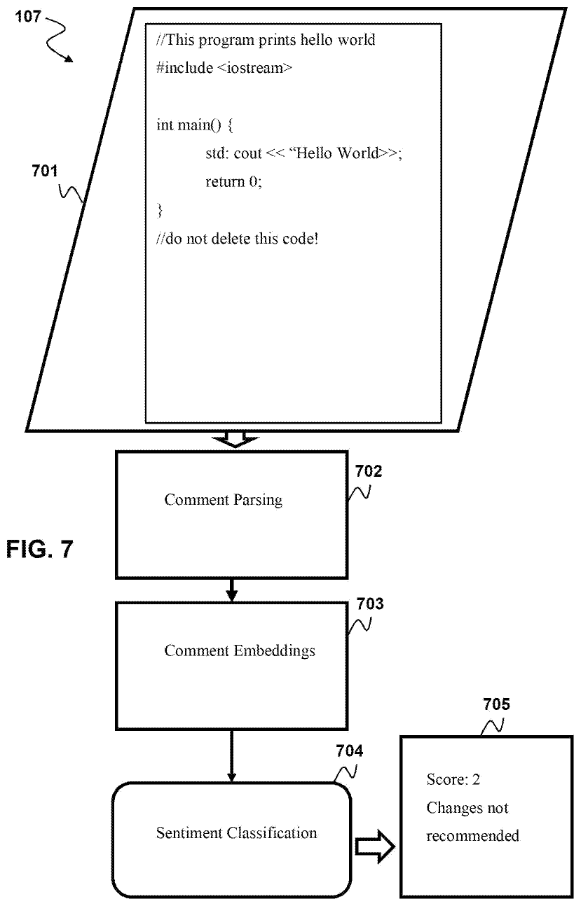

FIG. 7 is a diagram depicting comment sentiment analysis 107 according to aspects of the present disclosure. Application code 701 often includes comments from the developers who wrote the code. These comments may provide insight into the function and importance of code blocks from the developers that previously wrote the code. This insight may be useful in determining whether a particular code section or part of a code section is important to the function of other parts of the code or has a peculiarity that might affect modification or deletion. The comment sentiment analysis may analyze the comments and provide comment feature information 705 to the multimodal neural network. This comment feature information 705 may provide a comment score that captures the importance or fragility of the code section that will be modified by the update data.

To analyze comment sentiment the source code with comments may first be parsed, as indicated at 702. Comment parsing may remove special characters, punctuation and stop words. The comments may then be tokenized to divide the comment into words or phrases.

Comment embeddings are then extracted at 703 from the parsed comments. Comment embedding extraction may use a trained machine learning algorithm to convert the parsed comments to comment embeddings. Examples of comment embedding algorithms that may be used for embedding extraction include, for example and without limitation: Word2vec, or Global Vectors for Word Representation (GloVe).

Once comment embeddings are generated sentiment of the comments may be classified, as indicated at 704. Sentiment classification may be performed with a machine learning algorithm to classify sentiment from comment text. In some implementations the machine learning algorithm may be a pretrained neural network that may be specialized via transfer learning. Example pre-trained neural network models may include Generative Pre-trained Transformer (GPT), Bidirectional Encoder Representation from Transformers (BERT), or XLNet. These pre-trained models may be further trained using a training dataset that includes comments labeled with sentiment. The labeled dataset is masked during training and the pretrained models are refined with the appropriate machine learning algorithm.

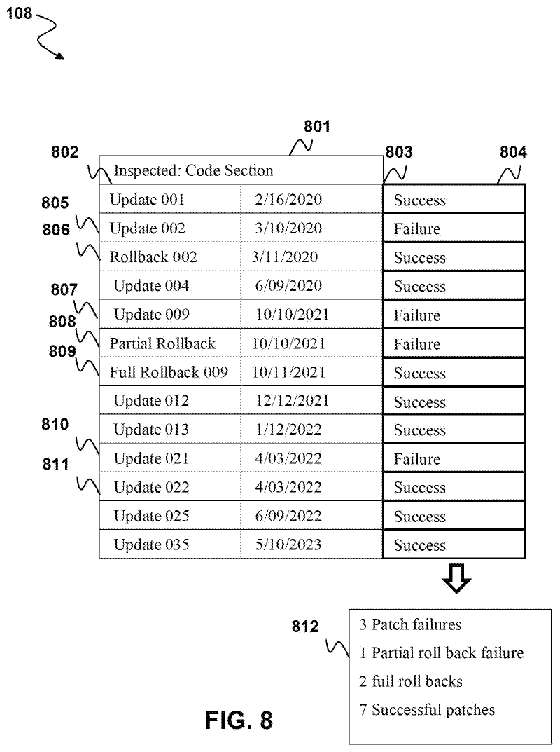

FIG. 8 is a diagram depicting an example of a failure map according to aspects of the present disclosure. As shown, the failure map 108 may include a table 801 listing the success or failure of updates to the code section under inspection. The table 801 may for example and without limitation include columns for update labels 802, date of the update 803 and outcome 804. In some implementations the code section is comprised of two or more code blocks, in such a case the update table 802 may display the outcome for each update made to each code block of the two or more code blocks.

In the example shown there have been many updates to the code section under examination. Here update 002 805 failed, which is reflected in the outcome column 804. Subsequently the update was rolled back 806, which was successful. The outcome information may be recorded by developers in the failure map as they release updates to the code. Alternatively, the failure map may parse update log files to populate the table. On-going logs may update the failure tracking. The ongoing logging process may be overridden manually if needed. A code rollback may change the code block to a previous version, thus eliminating changes made in a failed update. The failure of an update may be determined by the code developer based on an objective for the update. For example and without limitation, the objective for determining failure may be code functionality after update. As shown Update 009 807 resulted in a failure. The developers tried to partially roll back the code update 808 and this resulted in a failure. A partial roll back may roll back some portions of the code section or code blocks that are part of the code section to a previous iteration (here update 004) while leaving other portions of the code section or code blocks in the code section updated. The partial rollback 808 here was deemed a failure and a full rollback 809 was initiated and was successful. As shown Update 021 failed 810 and instead of rolling back the update, another update 022 811 was released.

In alternative implementations, assuming that all the unit and integration tests pass, a machine learning model may determine the probability that a code check-in will break any downstream systems.

In some implementations the failure map feature information may simply capture the number of failed updates made to the code section. In the implementation shown the failure map feature information 812 captures more detailed information regarding patching including number of partial roll backs, number of full rollbacks, number of successful patches and number of failed patches. The information included in the feature information may be selected to optimize the chances that the multimodal neural network will correctly predict the probability of an update causing a system failure.

### Multimodal Neural Network

The multimodal neural networks 110 fuse the feature information generated by the modules 102-108 for different modalities and generate a probability 111 that an update will lead to a system failure. Here modalities refers to the different types of information represented by the different information input to the different modules 102-108 and the different feature information output from the different modules 102-108. In some implementations the feature information from the separate modules may be concatenated together to form a single multi-modal vector. The multi-modal vector may also include the update data.

The output of a multimodal neural network 110 may include a determination of whether the update will cause a system failure and a probability. Alternatively, the output may simply be a probability or a binary determination as to whether the update may cause a system failure. The binary determination may simply be determined from a threshold for the failure probability that when at least met will result in the determination that the update will cause a crash.

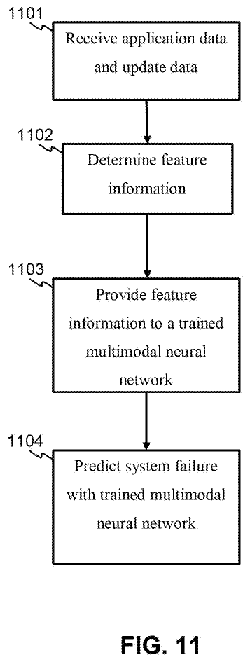

FIG. 11 is a block diagram showing the method of operation for prediction of a system wide failure from update data according to aspects of the present disclosure. Initially application data and update data may be received at 1101. The application and update data may be provided by a developer or as part of an automated check for code problems before pushing a software update. The system for prediction of update failures may run on a separate server or cloud computing system from the system that will be updated. Alternatively, the system for prediction of update failures may run on a separate, independent portion of the system being updated. The system may be deployed on the cloud and can be assessed by any service with appropriate security. Once the application and update data have been received the unimodal module may determine feature information using the application code and update data, as indicated at 1102. As discussed above, the unimodal modules 102-108 may be provided additional information such as social data, metadata regarding past updates and similar. After generation the feature information is provided to a multi-modal modal neural network trained to predict a system wide failure from the feature information 1103. The multi-modal neural network then generates a prediction as to whether a system wide failure will result from the feature information 1104. As discussed above the multi-modal neural network may generate a probability of a system wide failure or a simple binary decision.

The multi-modal neural networks 110 may be trained with a machine learning algorithm to take the multi-modal vector and predict a probability of a system failure 111. Training the multi-modal neural networks 110 may include end to end training of all of the modules with a data set that includes labels for multiple modalities of the input data. During training, the labels of the multiple input modalities are masked from the multi-modal neural networks before prediction. The labeled data set of multi-modal inputs is used to train the multi-modal neural networks with the machine learning algorithm after it has made a prediction as is discussed in the generalized neural network training section. To generate training data, a replica version of the system may be run in a sand boxed environment such that updates to the replica version of the system do not affect the production version of the system. Updates may be pushed to replica system and the effects may be observed to determine whether the update causes a system to fail. Developers may purposefully push updates that cause the replica system to fail to illustrate the types of updates that result in failure. Additionally, real crash data may be used as a source of labeled data for training. As an alternative to running a sandboxed application, the application may be run and evaluated in an offline production environment. The application may be deployed online after passing offline evaluation.

While aspects of the present disclosure are discussed in relation to a code section to be updated that may be comprised of code blocks aspects of the present disclosure are not so limited. The code section may be as small as a single line of code or as large as two or more files.

### Generalized Neural Network Training

The NNs discussed above may include one or more of several different types of neural networks and may have many different layers. By way of example and not by way of limitation the neural network may consist of one or multiple convolutional neural networks (CNN), recurrent neural networks (RNN) and/or dynamic neural networks (DNN). One or more of these Neural Networks may be trained using the general training method disclosed herein.

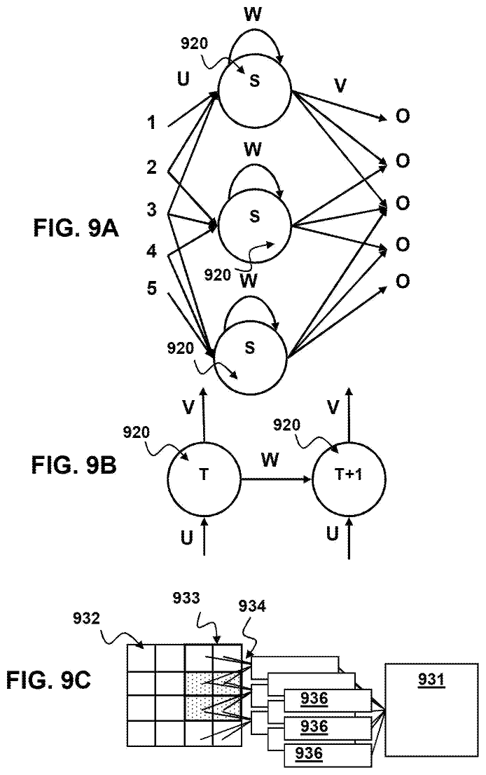

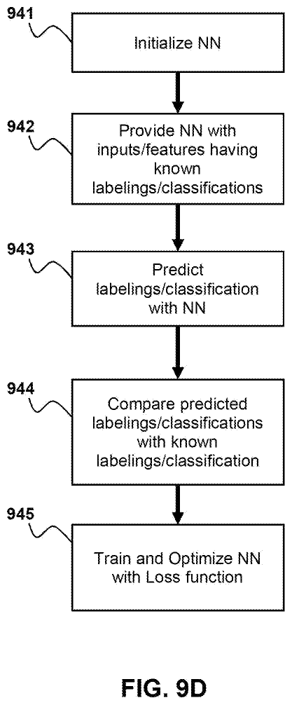

By way of example, and not limitation, FIG. 9A depicts the basic form of an RNN that may be used, e.g., in the trained model. In the illustrated example, the RNN has a layer of nodes 920, each of which is characterized by an activation function S, one input weight U, a recurrent hidden node transition weight W, and an output transition weight V. The activation function S may be any non-linear function known in the art and is not limited to the (hyperbolic tangent (tanh) function. For example, the activation function S may be a Sigmoid or ReLu function. Unlike other types of neural networks, RNNs have one set of activation functions and weights for the entire layer. As shown in FIG. 9B, the RNN may be considered as a series of nodes 920 having the same activation function moving through time T and T+1. Thus, the RNN maintains historical information by feeding the result from a previous time T to a current time T+1.

In some implementations, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9 (8): 1735-1780 (1997), which is incorporated herein by reference.

FIG. 9C depicts an example layout of a convolution neural network such as a convolutional recurrent neural network (CRNN), which may be used, e.g., in the trained model according to aspects of the present disclosure. In this depiction, the convolution neural network is generated for an input 932 with a size of 4 units in height and 4 units in width giving a total area of 16 units. The depicted convolutional neural network has a filter 933 size of 2 units in height and 2 units in width with a skip value of 1 and a channel 936 of size 9. For clarity in FIG. 9C only the connections 934 between the first column of channels and their filter windows are depicted. Aspects of the present disclosure, however, are not limited to such implementations. According to aspects of the present disclosure, the convolutional neural network may have any number of additional neural network node layers 931 and may include such layer types as additional convolutional layers, fully connected layers, pooling layers, max pooling layers, local contrast normalization layers, etc. of any size.

As seen in FIG. 9D Training a neural network (NN) begins with initialization of the weights of the NN at 941. In general, the initial weights should be distributed randomly. For example, an NN with a tanh activation function should have random values distributed between

$$- \frac{1}{\sqrt{n}} and \frac{1}{\sqrt{n}}$$

where n is the number of inputs to the node.

After initialization, the activation function and optimizer are defined. The NN is then provided with a feature vector or input dataset at 942. Each of the different features vectors that are generated with a unimodal NN may be provided with inputs that have known labels. Similarly, the multimodal NN may be provided with feature vectors that correspond to inputs having known labeling or classification. The NN then predicts a label or classification for the feature or input at 943. The predicted label or class is compared to the known label or class (also known as ground truth) and a loss function measures the total error between the predictions and ground truth over all the training samples at 944. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc., as indicated at 945. In each training epoch, the optimizer tries to choose the model parameters (i.e., weights) that minimize the training loss function (i.e., total error). Data is partitioned into training, validation, and test samples.

During training, the Optimizer minimizes the loss function on the training samples. After each training epoch, the model is evaluated on the validation sample by computing the validation loss and accuracy. If there is no significant change, training can be stopped, and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification. While the above discussion is relation to RNNs and CRNNS the discussions may be applied to NNs that do not include Recurrent or hidden layers.

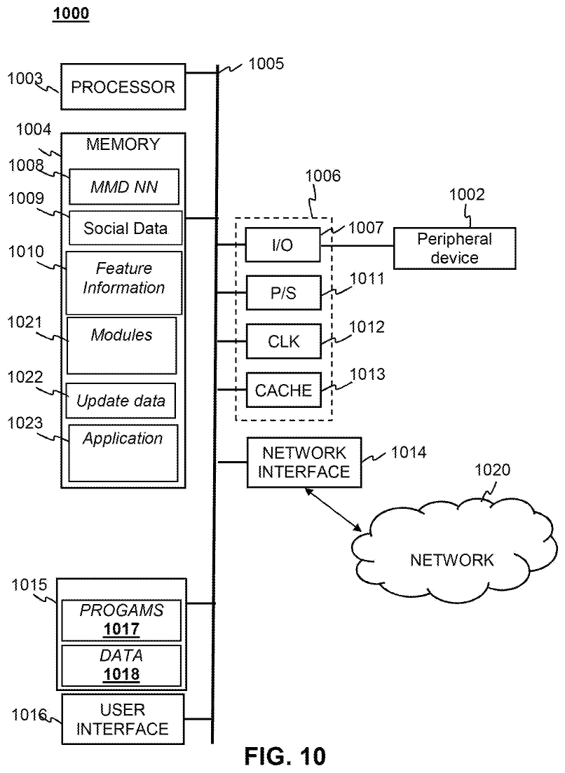

FIG. 10 depicts a system according to aspects of the present disclosure. The system may include a computing device 1000 coupled to a user peripheral device 1002. The peripheral device 1002 may be a controller, touch screen, microphone or other device that allows the user to input speech data into the system. Additionally, the peripheral device 1002 may also include one or more IMUs.

The computing device 1000 may include one or more processor units and/or one or more graphical processing units (GPU) 1003, which may be configured according to well-known architectures, such as, e.g., single-core, dual-core, quad-core, multi-core, processor-coprocessor, cell processor, and the like. The computing device may also include one or more memory units 1004 (e.g., random access memory (RAM), dynamic random-access memory (DRAM), read-only memory (ROM), and the like).

The processor unit 1003 may execute one or more programs, portions of which may be stored in memory 1004 and the processor 1003 may be operatively coupled to the memory, e.g., by accessing the memory via a data bus 1005. The programs may be configured to implement training of a multimodal NN 1008. Additionally, the Memory 1004 may contain programs that implement training of a NN configured to generate feature information 1010. Memory 1004 may also contain software modules such as a multimodal neural network module 1008, and Specialized Modules 1021. The multimodal neural network module and specialized modules are components of a system failure prediction engine, such as the one depicted in FIG. 1. The Memory may also include one or more applications 1023 including commented code of the application, update data 1022 for the application and social data 1009 about one or more authors of the application code. The overall structure and probabilities of the NNs may also be stored as data 1018 in the Mass Store 1015. The processor unit 1003 is further configured to execute one or more programs 1017 stored in the mass store 1015 or in memory 1004 which cause the processor to carry out a method for training a NN from feature information 1010 and/or input data. The system may generate Neural Networks as part of the NN training process. These Neural Networks may be stored in memory 1004 as part of the Multimodal NN Module 1008, or Specialized NN Modules 1021. Completed NNs may be stored in memory 1004 or as data 1018 in the mass store 1015.

The computing device 1000 may also include well-known support circuits, such as input/output (I/O) 1007, circuits, power supplies (P/S) 1011, a clock (CLK) 1012, and cache 1013, which may communicate with other components of the system, e.g., via the data bus 1005. The computing device may include a network interface 1014. The processor unit 1003 and network interface 1014 may be configured to implement a local area network (LAN) or personal area network (PAN), via a suitable network protocol, e.g., Bluetooth, for a PAN. The computing device may optionally include a mass storage device 1015 such as a disk drive, CD-ROM drive, tape drive, flash memory, or the like, and the mass storage device may store programs and/or data. The computing device may also include a user interface 1016 to facilitate interaction between the system and a user. The user interface may include a keyboard, mouse, light pen, game control pad, touch interface, or other device.

The computing device 1000 may include a network interface 1014 to facilitate communication via an electronic communications network 1020. The network interface 1014 may be configured to implement wired or wireless communication over local area networks and wide area networks such as the Internet. The device 1000 may send and receive data and/or requests for files via one or more message packets over the network 1020. Message packets sent over the network 1020 may temporarily be stored in a buffer in memory 1004.

Aspects of the present disclosure leverage artificial intelligence to predict a system failure from readily available patch data, crash data and social networks. The crash data and update information can be analyzed and mapped along with simulated crashes to create a labeled crash dataset that may then be used to train a system to predict from an update and/or information about the update whether a system failure will probably result from the update.

Additionally, the system may output the probability that the update will result in a system crash.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A device for predicting a system failure from update data comprising;
a connectivity map configured to determine connectivity of code blocks to a code section that will be modified by update data and output at least a number of connected code blocks as connectivity feature information;
a history map configured to determine a frequency of updates to the code section that will be modified by the update data and output at least a number of changes to the code section as historical feature information;
an activity map configured to determine a number of times the code section that will be modified by the update data is accessed in a time period and at least output the number of times the code section that will be modified is accessed in the time period as activity feature information;
a neural network trained with a machine learning algorithm to predict a system failure probability for the code update data that modifies the code section using at least the connectivity feature information, historical feature information and activity feature information.

2. The device of claim 1 further comprising a complexity map, wherein the complexity map is configured to determine a size of the code section that will be modified by the update data and output at least the size of the code section that will be modified by the update data as complexity feature information and the neural network is additionally trained using the complexity feature information.

3. The device of claim 1 further comprising a social map, wherein the social map is configured to determine a trust score for the update data and output at least a trust score for the update data as social feature information wherein the trust score includes at least a number of other successful code section changes made by a person that created the update data and wherein the neural network is additionally trained using the trust score.

4. The device of claim 3 wherein the trust score further includes a tenure of the person that created the update data.

5. The device of claim 3 wherein the trust score includes a score for rank or title within an organization for the person that created the update data.

6. The device of claim 1 further comprising a comment sentiment analysis module configured to determine the sentiment of code comments in the code section that will be modified by the update data and outputs at least a score for sentiment as comment feature information wherein the neural network is additionally trained using the score for sentiment.

7. The device of claim 6 wherein the comment sentiment analysis module includes a sentiment analysis neural network trained with a machine learning algorithm to determine sentiment from text strings in the comments of code.

8. The device of claim 1 further comprising a failure map configured to determine a number of failures the code section that will be modified by the update data has experienced due to past updates and output the number of failures the code section that will be modified by the update data has experienced due to past updates as failure feature information wherein the neural network is additionally trained using the failure feature information.

9. The device of claim 8 wherein the failure feature information further includes a number of reverts to original code.

10. The device of claim 1 wherein the code section includes an entire file.

11. The device of claim 1 wherein the code section includes multiple files.

12. A method for predicting a system failure from update data comprising:
determining connectivity feature information including at least a number of connected code blocks with a connectivity map, wherein the connectivity map is configured to determine connectivity of code blocks to a code section that will be modified by update data;
determining historical feature information including at least a number of changes to the code section with a history map, wherein the history map is configured to determine the frequency of updates to the code section that will be modified by the update data;
c. determining activity feature information including a number of times the code section that will be modified by the update data is accessed in a time period with an activity map configured to determine a number of times the code section that will be modified by the update data is accessed in the time period;
providing the connectivity feature, historical feature information, and activity feature information to a neural network trained with a machine learning algorithm to predict a system failure probability for the code update data that modifies the code section.

13. The method of claim 12 further comprising claim 1 further comprising determining complexity feature information including at least the size of the code section that will be modified by the update data with a complexity map wherein the complexity map is configured to determine the size of the code section that will be modified by the update data and providing the complexity feature information to the neural network

14. The method of claim 12 further comprising, determining a trust score including at least a number of other successful code section changes made by a person that created the update data with a social map wherein the social map is configured to determine the trust score for the update data and providing the trust score to the neural network.

15. The method of claim 14 wherein the trust score further includes a tenure of the person that created the update data.

16. The method of claim 14 wherein the trust score includes a score for rank or title within an organization for the person that created the update data.

17. The method of claim 12 further comprising determining a sentiment score including a score based on a sentiment analysis of comments in the codes section that will be modified by the update data.

18. The method of claim 17 wherein the comment sentiment analysis includes using a sentiment analysis neural network trained with a machine learning algorithm to determine sentiment from text strings in the comments of code.

19. The method of claim 12 further comprising determining failure feature information including a number of failures the code section that will be modified by the update data has experienced due to past updates with a failure map configured to determine the number of failures the code section that will be modified by the update data has experienced due to past updates.
